(19) United States
(12) Patent Application Publication
(10) Pub. No.: US 2007/0192082 A1
(43) Pub. Date: Aug. 16, 2007

(54) SYSTEM AND METHOD FOR GENERATING AND EXECUTING A PLATFORM EMULATION BASED ON A SELECTED APPLICATION

(76) Inventors: Maria Gaos, Edmonds, WA (US); Nazih Youssef, Bothell, WA (US)

Correspondence Address: AXIOS LAW GROUP, 1725 WESTLAKE AVENUE NORTH, SUITE 150, SEATTLE, WA, 98109, US

(21) Appl. No.: 11/674,636

(22) Filed: Feb. 13, 2007

Related U.S. Application Data
(60) Provisional application No. 60/766,822, filed on Feb. 13, 2006.

(51) Int. Cl. G06F 9/455

(52) U.S. Cl. 703/27

(57) ABSTRACT

A system operative to generate a platform emulation based on a selected application program, the system comprising a user device, an electronic device, a networked link between the user device and the electronic device, the user device including a plurality of components and having information stored thereon for generating the platform emulation, the user device operative to execute the platform emulation and to execute the application program on the platform emulation and the electronic device operative to display information from the execution of the application program on the platform emulation.

### CROSS-REFERENCE TO RELATED APPLICATIONS

This application is based upon and claims the benefit of priority from Provisional Application No. 60/766,822 filed Feb. 13, 2006, the entire contents of which are incorporated herein by reference.

### FIELD

The present disclosure relates generally to information processing, and in particular but not exclusively, relates to a method and system for custom configuration of electronic user devices.

### BACKGROUND

Communications between electronic devices have improved in recent years. Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links.

An internetwork, in turn, is the joining of multiple computer networks, both similar and dissimilar, by means of gateways or routers that facilitate data transfer and conversion from various networks. A well-known abbreviation for the term internetwork is “internet.” As currently understood, the capitalized term “Internet” refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

However, the ever-increasing pace of technological change is forcing many users of electronic devices to continuously spend significant sums of money on the newest or fastest devices simply to maintain their current computation needs. The rapid pace at which each new generation of technologies is introduced into the marketplace renders each preceding generation of technologies obsolete. Furthermore, the increasing number of user devices in households often produces unnecessary redundancies in capabilities and unforeseen challenges relating to inter-device communications. Thus, there is a growing need for a wide range of user devices that can adapt to successive changes in technologies without requiring increasingly significant investments of capital by end users. Additionally, this critical need desperately requires a solution that can minimize or eliminate user device redundancy and greatly facilitate communications between various user devices regardless of the nature and pace of successive changes in technologies.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagram illustrating a communications network including multiple processing nodes and communications with multiple geographic locations in an embodiment.

FIG. 2A is a block diagram illustrating a representative set of devices coupled to a set-top box in an embodiment.

FIG. 2B is a block diagram illustrating a representative set of configurable user devices coupled to a communications network in an embodiment.

FIG. 3 is a block diagram illustrating a configurable electronic device in an embodiment.

FIG. 4A is a flowchart illustrating a method for application execution on a configurable hardware and software platform in an embodiment.

FIG. 4B is a flowchart illustrating a method for hardware emulation, software optimization and support software retrieval in an embodiment.

FIG. 4C is a flowchart illustrating a method for emulation selection and activation in an embodiment.

FIG. 4D is a flowchart illustrating a method for creating and executing an emulation architecture in an embodiment.

FIG. 5A is a flowchart illustrating a method for application selection and emulation architecture generation in an embodiment.

FIG. 5B is a flowchart illustrating a method of monitoring for a user request for an emulation architecture in an embodiment.

FIG. 6A is a method for determining an optimum emulation architecture for a downloaded application in an embodiment.

FIG. 6B is a method for selecting and generating an emulation architecture in an embodiment.

FIG. 6C is a method for generating and enabling an optimum emulation architecture in an embodiment.

### DETAILED DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to or combined without limiting the scope to the embodiments disclosed herein.

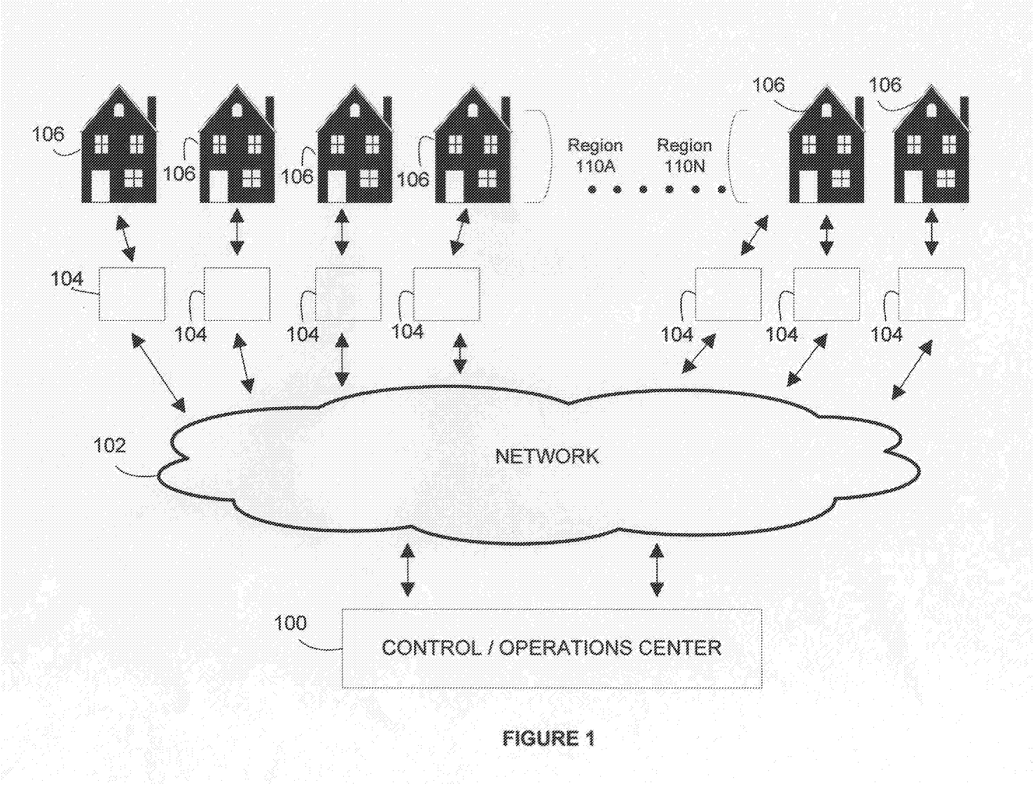

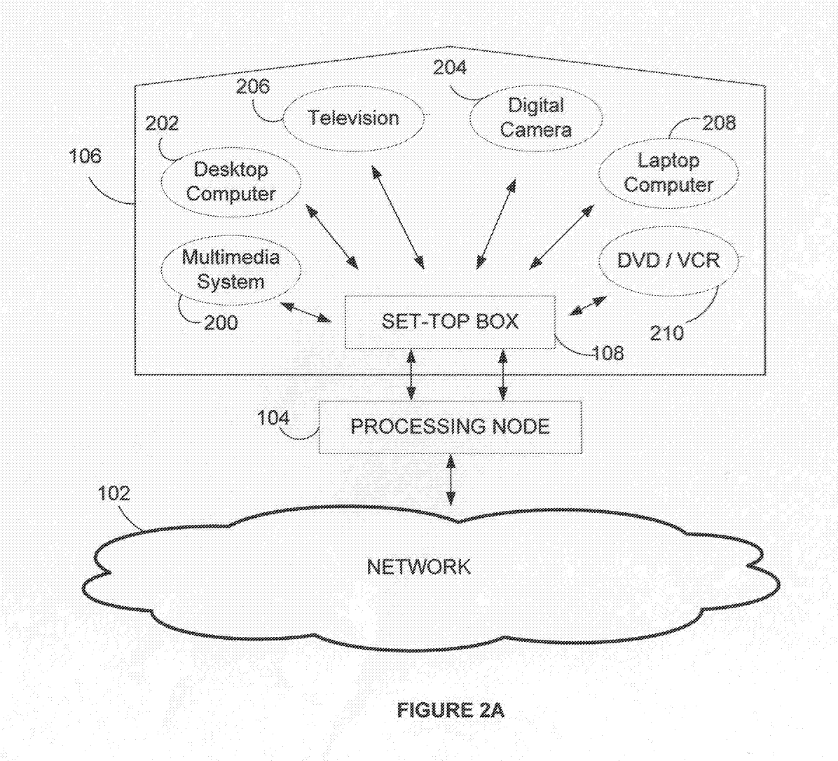

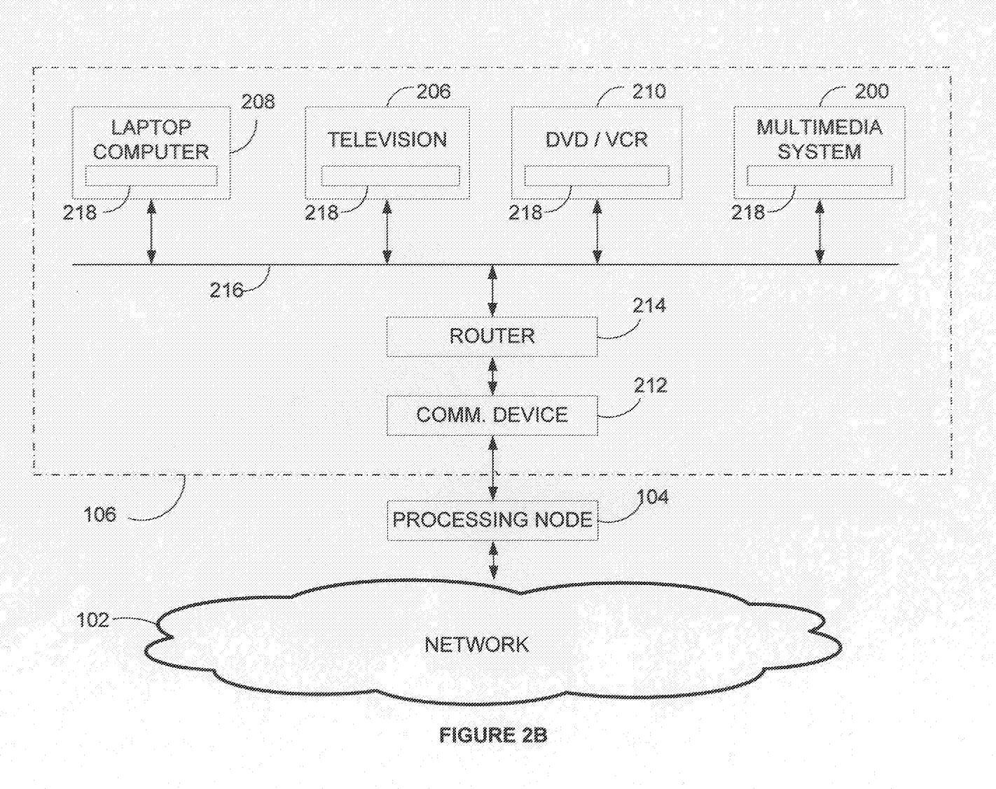

FIG. 1 is a block diagram of an exemplary embodiment of an information processing system. The information processing system includes several components, a control and operations facility 100, a communication network 102, a plurality of intermediate processing nodes 104, and a plurality of geographic regions 1110A-110N. Each region includes a plurality of households and different properties. Each household 106 includes a user device, which in an embodiment is a set-top box 108 (shown FIG. 2A), that is coupled to a plurality of electronic devices used by an end user or consumer. The communication network 102 provides a choice of communication media including a private network, high bandwidth networks (cable network, DSL, T1 and the like), public switched telephone network (“PSTN”), satellite network or Internet, etc. Each geographic region 110 covers a distinct geographic area and includes a plurality of households and the information processing requirements of each household are provided through the plurality of intermediate processing nodes 104 and enabled by communication through communication network 102 to and from the control and operations facility 100. The control and operations facility 100 includes at least a remote host server that provides for the computing and information processing requirements of each user device 108 provided in each household.

FIG. 2A includes a communication network 102 that communicates through intermediate node 104 to an illustrative embodiment of a household 106. Household 106 includes a set top box in an exemplary embodiment. The set top box 108 communicates with a plurality of household electronic and consumer devices. Among the internal household devices to which the set top box 108 may communicate are multimedia systems 200, desktop computer systems 202, digital cameras 204, TVs or televisions 206, laptop computers 208, DVDs and VCR controllers 210, and a plurality of handheld computing devices (e.g., blackberry, blueberry handheld computers). Each intermediate node 104 is assigned a geographic region 110 to which information messages are passed back and forth between the control communications facility 100 and the plurality of user devices 108 provided in each household 106. A plurality of intermediate nodes may be assigned to handle the information processing requirements for each geographic region, the control and operations facility 100 will insure adequate load balancing and redistribution of processing capabilities between and among intermediate processing nodes to support the processing required in each distinct geographic region 110.

FIG. 2B provides yet another exemplary embodiment of the information processing system. In this figure, communication network 102 and then communication with intermediate node 104 to a household 106 through a communication device 212 which is coupled to router 214 which is in turn coupled to a household local area network 216. Each of the plurality of household consumer devices are coupled to local area network 216 to facilitate information transfer and necessary processing of user request and control center commands to the user device 218. As shown in this figure, electronic device 208 (laptop computer) includes an embedded module that is an embodiment of the user device 218. Likewise, television 206 includes an embedded user device 218 along with embedded user devices 218 included in the other illustrative embodiments of electronic devices such as DVD, VCR recorder 210 and multimedia system 200. In this configuration of the information processing system there is no centralized user device 108 but rather a plurality of embedded modules including the capabilities of user device 108 which modules have been embedded in each of a plurality of electronic devices available for use by a household end user. This is a representative example of a decentralized embodiment and thereby facilitates custom configuration of each electronic user device and each embedded user device to the specific needs of the end user.

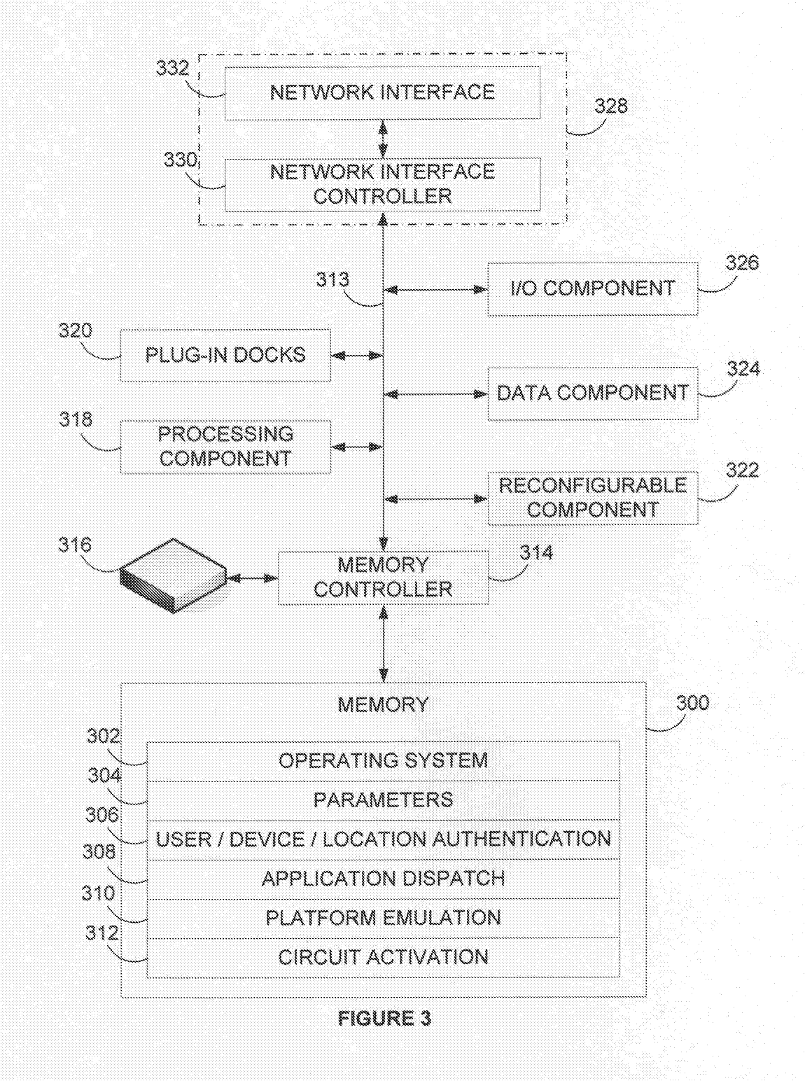

FIG. 3 includes a block diagram of an exemplary embodiment of the user device 108, 218, having a memory 300, a memory controller 314, a hard drive 316, a reconfigurable component 322, a data component 324, an input/output component 326, a plurality of plug-in docs 320, a processing component 318 and a network interface component 328. Each of the components is coupled together along a common bus 313 in the computing architecture as shown in FIG. 3. Network interface component 328 includes a network interface controller 330 coupled to a network interface 332. Network interface controller 330 controls which type of interface the user device is coupled to for communication to and from the control and operations facility 100 and in the embodiment shown in FIG. 2B the communication to and from each embedded electronic device. Input output component 326 is coupled to each of the plurality of electronic devices included in the household to enable the user device 108 to communicate with each device to determine and monitor each user's application selection on each of these devices. The data component 324 includes a storage capability to record each selection made by a user of an application to be executed on an electronic device and includes additional storage capabilities to record the frequency with which such applications are selected. Reconfigurable component 322 includes a hardware component to enable the reconfiguration of embedded hardware circuitry to enable the execution of supplemental or advanced computing capabilities to enhance the use of the selected application desired by a user of an electronic device. Hard drive 316 stores applications that were used previously by end users of the electronic devices. Processing component 318 provides the essential processing capability of the user device and is used to process request based on application selections made by end users of electronic devices for execution of specific applications or the retrieval and execution of specific platform emulations to enable the execution of selected applications by users of the electronic devices. The plurality of plug-in docs 320 is provided to received plug-in cartridges having application stored thereon for execution on specific electronic devices. The processing component 318 will determine which electronic device the application will be displayed on based on the specific needs and characteristics of the target electronic device as determined by information provided by input output component 326. Memory controller 314 is coupled to hard drive 316 and memory 300 and is used to process request from the processing component 318 for access to applications or to access parameters or programs stored in memory 300. Memory 300 includes a stored operating system 302, a set of parameters 304, an authentication program for authenticating a user, a device, and the location of the device and the user. Application dispatch program 308 is also stored in memory 300, platform emulation program 310 is stored in memory 300 and circuit activation program 312 is also stored in memory 300.

The parameters 304 stored in memory 300 are comprised of application specific parameters and emulation parameters. Application parameters are received by input-output component 326 and stored in memory 300 after a user makes a selection for a particular application. Authentication program 306 authenticates the user, the device and the location of the device and the user based on additional information gathered by input-output component 326. Application dispatch program 308 is executed by processing component 318 if the selected application is not stored in the user device 108 on hard drive 316. Application dispatch program 308 upon execution issues a request to a remote host server and control and operations facility 100 to retrieve the application from a plurality of stored applications on the remote host server, the retrieved application is thereafter stored in hard drive 316. The application dispatch program 308 is also used to issue requests to the remote host server and central and operations facility 100 to generate application specific emulations or platform emulations that are to be used and executed on the user device 108 to support the execution of the selected application made by the end use of an electronic device such as a laptop computer 208, a television set 206 or multimedia system 200. The platform emulation 310 stored in memory 300 represents previously executed platform emulations and parameters 304 would include the corresponding parameters required by the processing component 318 to execute a previously stored and executed platform emulation 310. Circuit activation program 312 is executed by processing component 318 to configure hardware circuits in a desired configuration using the reconfigurable component 322 to enable the execution of a desired platform emulation or a desired selected application.

Application dispatch program 308 will issue a request to have the remote host server and control and operations facility 100 generate a new platform emulation when the processing component 318 determines based on the selected application that the required hardware platform or platform emulation is not stored in hard drive 316 or in memory 300. The request to have a platform emulation generated includes a set of application parameters and an emulation specific request, both the parameters and the emulation specific request are provided to the remote host server for the generation of a desired platform emulation. After generation of the platform emulation, the remote host server downloads the platform emulation to the user device 108 and it is thereafter stored on hard drive 316. The remote host server downloads both the platform emulation and the emulation parameters required for execution of the platform emulation in a manner that supports execution of the selected application made by an end user of an electronic device. Operating system 302 and memory 300 may be any of a number of conventional operating systems or embedded real time operating systems for execution in the user device 108 with processing component 308.

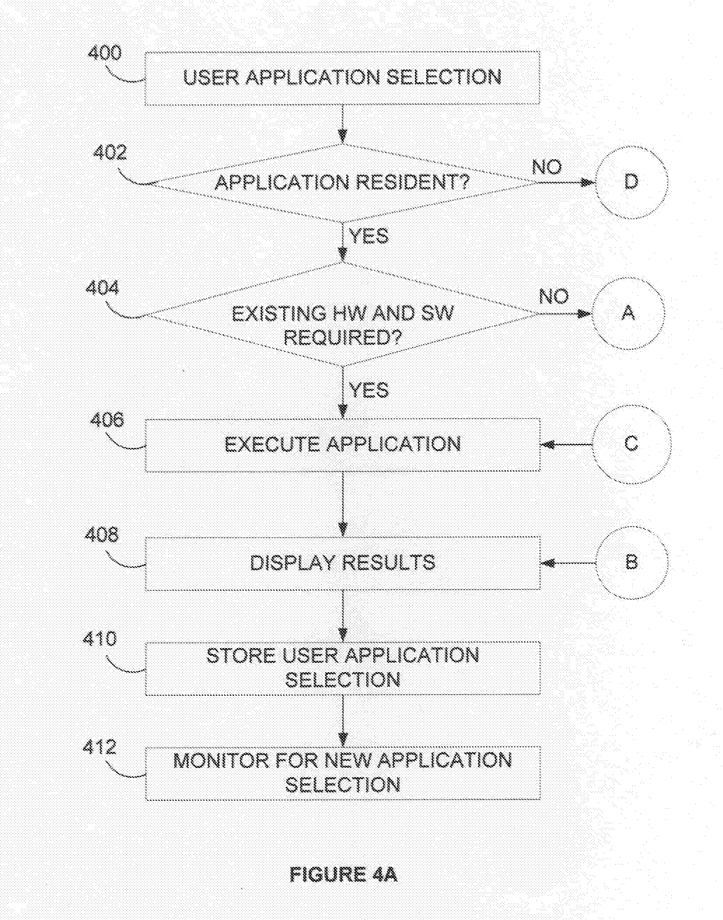

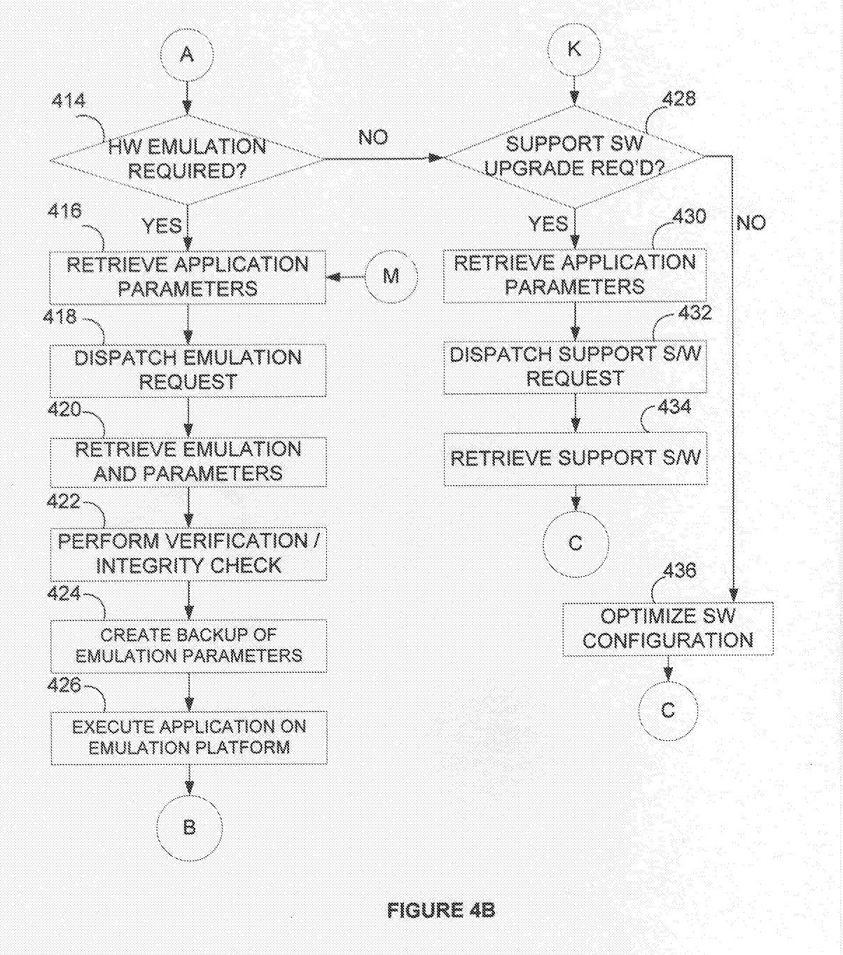

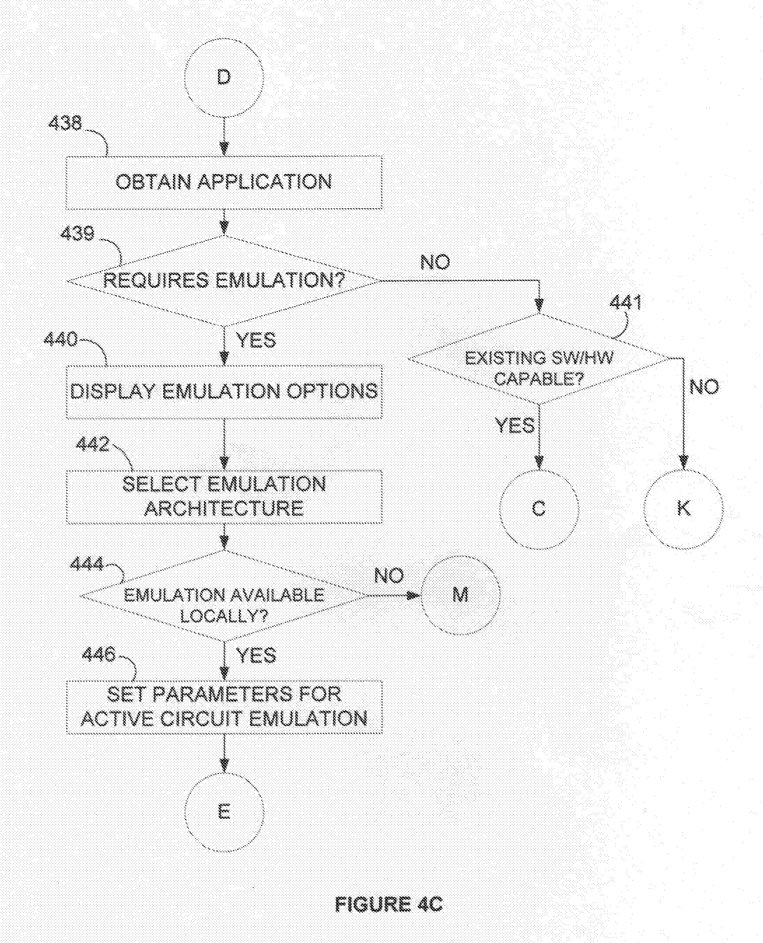

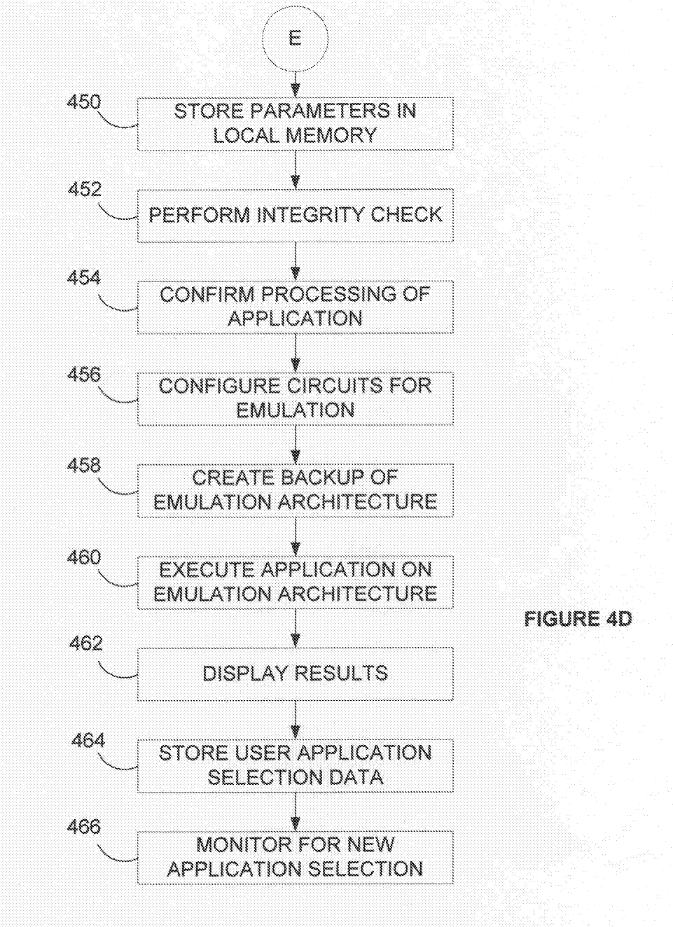

FIG. 4A is a flow diagram outlining the general flow of operation of the user device upon receiving a user application selection. As shown in this figure, user application selection 400 initiates an internal process to determine whether the selected application is resident as shown at step 402. If the application selected by the user is resident on the user device 108 (or in the alternative embodiment of an embedded module shown in FIG. 2B (module 218)) then the user device will determine whether the existing hardware and software platform is sufficient to execute the desired application as shown at step 404. If the existing hardware and software architecture are sufficient to execute the application, then the user device will execute the application as shown at step 406. The results of the execution of the application will be displayed on the desired electronic device as shown at step 408 and the selection made by the user of the desired application will be identified and then the user device will enter into a wait state and continue to monitor for a new user application selection as shown at step 412.

In the event the application is not resident as determined by the analysis of step 402 then the user device will proceed to obtain the required application as shown at step 438, shown in FIG. 4C. In obtaining the desired application, the user device may retrieve the application from hard drive 316 or activate the application dispatch program 308 and have it issue a request which will include application parameters 304 to have the remote host server in control and operations facility 100 generate the applications which will subsequently be downloaded by the remote host server to the user device 108.

As shown in FIG. 4C, obtaining the application (step 438) initiates an internal process to determine whether the downloaded application requires emulation as shown at step 439. If the application does not require emulation, then the device proceeds to determine if the existing SW/HW are capable 441 of executing the application. If the user device is capable of executing the application, it then proceeds to execute the application (step 406 in FIG. 4A). If the user device is not capable of executing the application, then the device proceeds to determine if support software is needed to upgrade the application for execution on the user device (step 428 in FIG. 4B).

Returning to FIG. 4C, in the event the application requires emulation then the user device will display emulation options on the electronic device for additional input from an end user, as shown at step 440. Input information is provided by the end user to select a specific or target emulation architecture as shown at step 442 and then the user device will then determine whether the emulation is available in its local memory as shown at decision step 444. If the emulation is not available locally then a request will be made by the application dispatch program 308 to have the remote host server retrieve application parameters as shown at step 416 in FIG. 4B. This process is followed by several steps requiring the dispatch of an emulation request (step 418), the retrieval of an emulation and its parameters (step 420), the performance of a verification and integrity check (step 422), the creation of backup emulation parameters (step 424) and the execution of the application on the emulation platform. In the event the emulation is available locally, the platform emulation will be retrieved from memory and the emulation parameters required for its execution will be set to an active state again as shown at step 446.

After the emulation parameters are received from the generation of a platform emulation by the remote host server those parameters are stored in the local memory as shown at step 450. The processing component 318 will then perform an integrity check as shown at step 452 to ensure that the platform emulation functions as specified for the required hardware architecture needed by the selected application. The processing component 318 will also confirm the processing requirements of the application as shown at step 454 and then proceed to configure all circuits both hardware circuits and soft circuits for execution of the platform emulation as shown at step 456. The processing component 318 will continue its execution and create a backup or replication copy of the platform emulation as shown at step 458 and then proceed with the execution of the selected application on the platform emulation as shown at step 460. Afterwards the results from the executed application will be displayed as shown at step 462 on the electronic device of choice by the end user and the selection made by the user of the particular application will be stored in the data component 324. The data component 324 includes a data store for storing the frequency with which particular user applications are selected and the types of applications that are selected so that the control and operations facility will ultimately be able to determine the number of times particular applications are selected by end users in specific geographic regions and thereby shift or moderate information processing capabilities across its network of intermediate processing nodes and make available specific applications for specific geographic regions after learning or compiling additional data that enables the control and operations facility to learn the types of application usage patterns that are common to end users in specific geographic regions. After storing application selection data in step 462 the processing component 318 and the user device will then move into a wait state and continue monitoring for a new application selection as shown at step 466.

Returning now to FIG. 4A, in the event the application is resident but is incompatible with or cannot be executed on the existing hardware and software architecture as shown at step 404, then the process shown in flow diagram of FIG. 4B will be executed. If emulation is required then the processing component 318 will retrieve the application parameters from the input-output component 326 and store them in memory 300 as shown at step 416. Afterwards the processing component 318 will execute the application dispatch program 308 to issue a request as shown at step 418 to have a new platform emulation generated by remote host server in control and operations facility 100. The platform emulation will be retrieved at step 420 and downloaded from the control and operations facility 100 and stored on hard drive 316 in the user device along with emulation parameters to enable processing component 318 to successfully execute the platform emulation. After download of the platform emulation and its corresponding parameters, processing component 318 will perform a verification and a series of integrity checks on the platform emulation as shown at step 422. Next, processing component 318 will create a backup of the platform emulation and its corresponding emulation parameters as shown at step 424 and then execute the application on the platform emulation as shown at step 426. Processing component 318 will then display the results of the execution of the application as shown at step 408 and store the application selection in the data component 324 which is shown and reflected at step 410 and then proceed to monitor for additional or new application selections as shown at step 412.

Returning to step 414 where the user device determines whether hardware emulation is required, if hardware emulation is not required then the processing component 318 will determine whether additional support software will be required or whether an upgrade to the supporting software will be required to properly execute the selected application as shown at step 428. If an upgrade of the support software is required, the processing component 318 will retrieve the application parameters as shown in 430 and execute application dispatch program 308 to have a request sent to the remote host server and control an operation facility 100 as shown at step 432 to have support software generated by the remote host server which will subsequently be retrieved and downloaded as shown at step 434 to the user device. The processing component 318 in user device 108 will then execute the selected application as shown at step 406 display its results on the desired electronic device as shown at step 408 and then store that application selection as shown at step 410 in data component 324 and then monitor all electronic devices coupled to the user device for new application selections as shown at step 412.

Returning to FIG. 4B, in the event a support software upgrade is not required as determined in step 428 then the user device will proceed to optimize the default software configuration for operation with the selected application. The selected application will be executed as shown at step 406 and the results of the executed application will be displayed on the target electronic device as shown at step 408 and the particular selection made by the user on the designated electronic device will be stored in data component 324 and subsequently the user device will return to a wait state and monitor for another new application selection by an end user as shown at step 412.

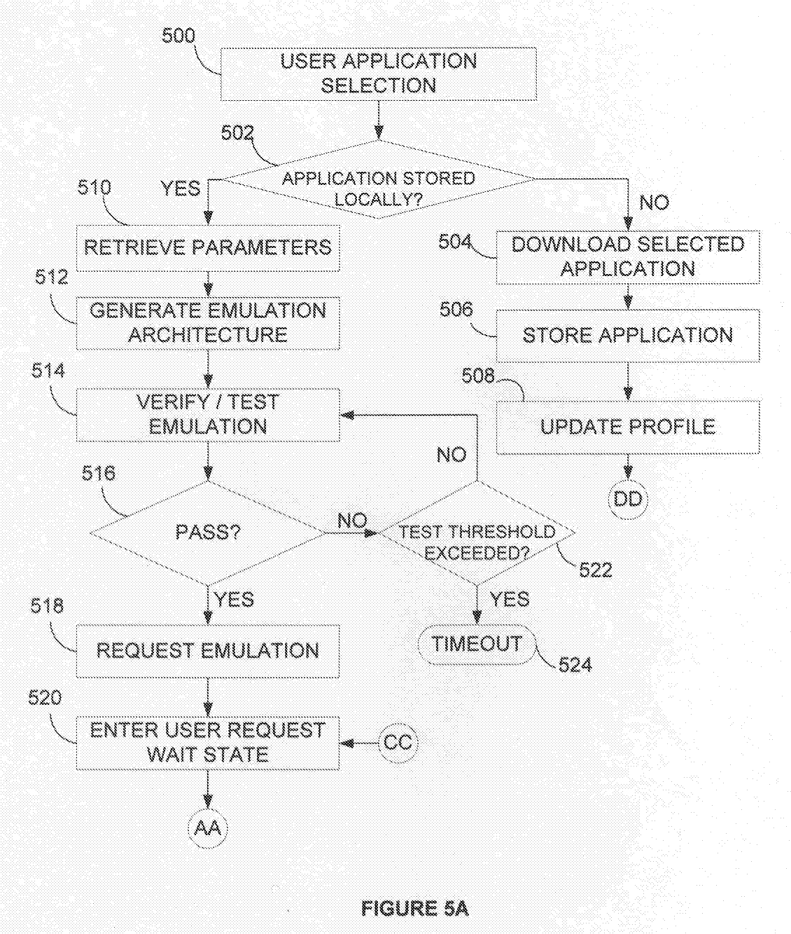

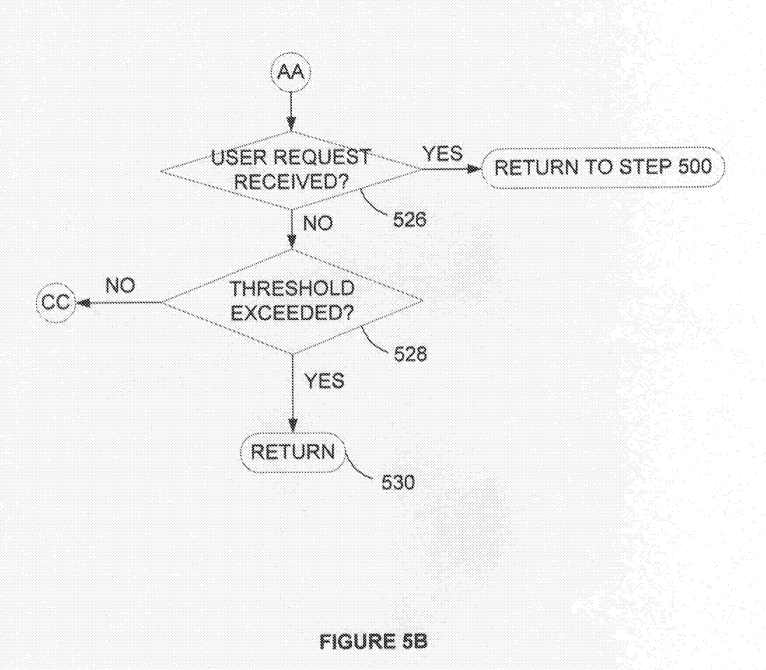

FIG. 5A includes a flow diagram of the application dispatch process executed by application dispatch program 308. Initially, the user device awaits a user application selection which occurs as shown at step 500. After receiving notice of the user application selection from input-output component 326, the processing component 318 will determine whether the application that has been selected is stored locally in the user device as shown at step 502. If the application is not stored locally then it will be downloaded from the remote host server and control and operations facility 100 as shown at step 504 and stored in a local memory as shown at step 506. The user profile included in the data component which includes the profile of applications selected and the frequency with which applications have been selected will then be updated at step 508 to reflect the additional selection of this application.

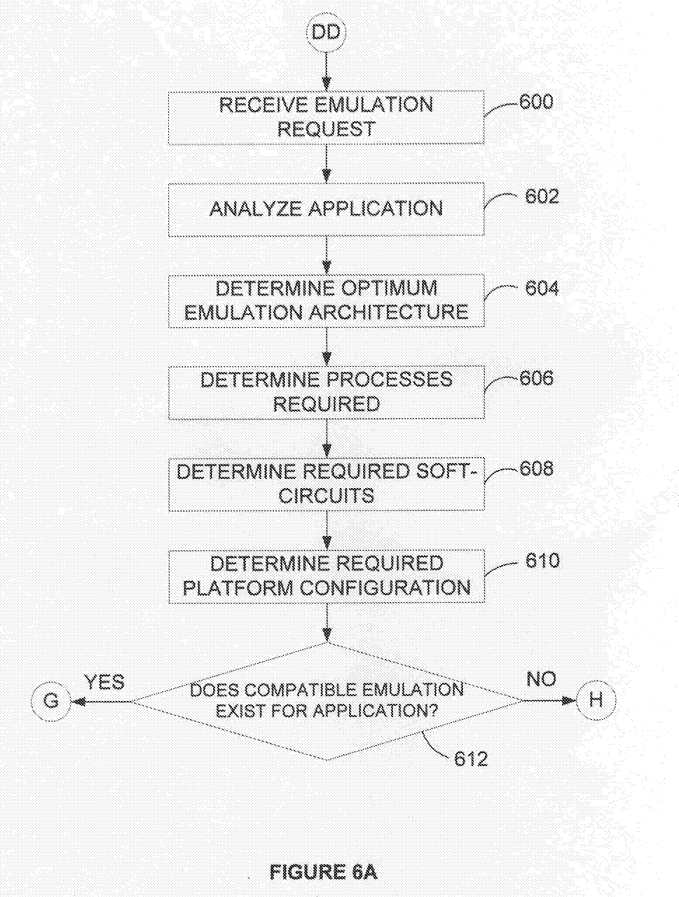

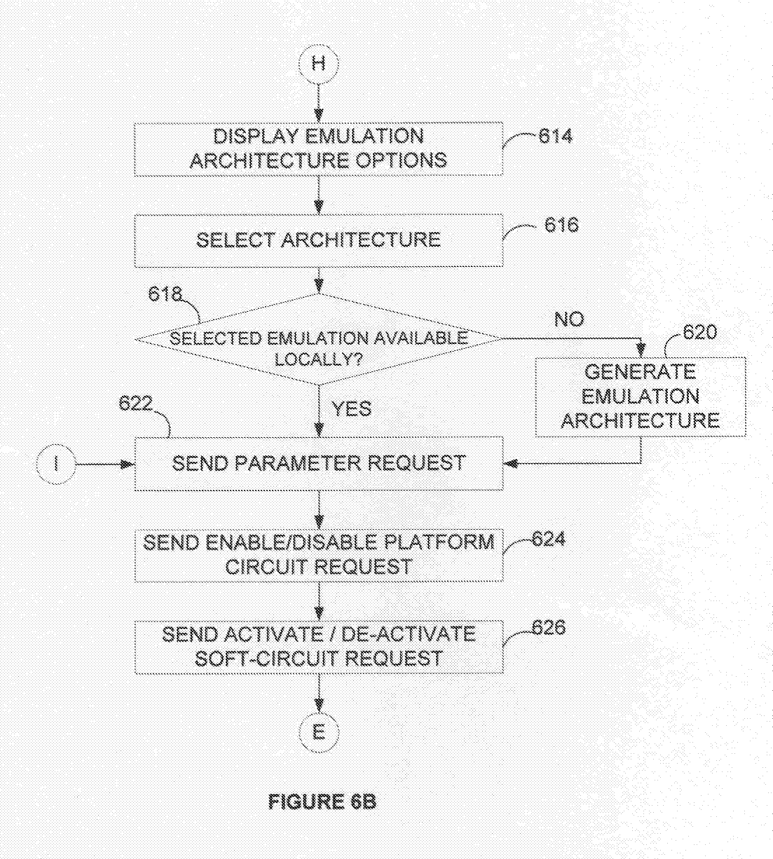

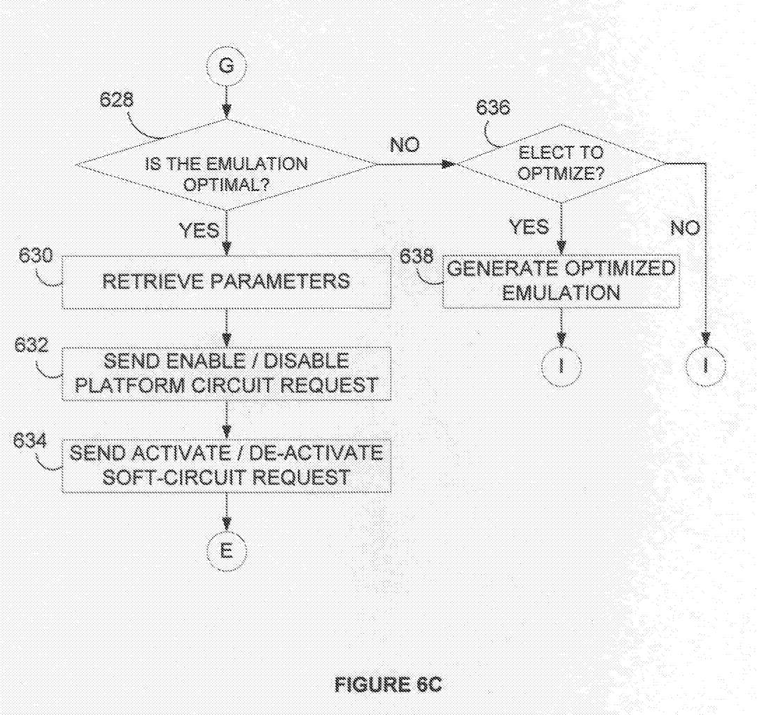

As shown in FIG. 6A, if the central processing component 318 determines that a platform emulation is required for execution of the selected application and the platform emulation is not resident locally, then processing component 318 will issue a request to the circuit activation program to perform an analysis of the selected application as shown at step 602. The circuit activation program then will proceed to determine the optimum platform emulation architecture as shown at step 604. The analysis performed by the circuit activation program will include determining the necessary processes that must be executed by the platform emulation as shown at step 606. The determination of the required soft circuits that must be included and executed in a platform emulation as shown at step 608 and the required hardware configuration to be implemented by reconfigurable component 322 in support of the platform emulation as shown at step 610. The circuit activation program will then determine whether a compatible platform emulation is available locally for execution of the selected application as shown at decision step 612. If the application is not available locally then the process set forth in FIG. 6B will be pursued.

FIG. 6B shows the flow diagram in which the user device displays platform emulation options for the user as shown at step 614 among the range of platform emulation options may be an Apple Mac computer platform, an IBM personal computer option and electronic games platform and other computing alternatives. Upon receipt of a selection of a platform emulation architecture as shown at step 616 the user device will then determine whether the selective platform emulation is available locally as shown at decision step 618. If the platform emulation is not available locally then a request will be issued by the user device to have the platform emulation generated by the remote server located at the control and operations facility 100 as shown which process is reflected by step 620. After generation and download of the required platform emulation, the circuit activation program will then compile the received emulation parameters which were downloaded with the platform emulation received from the remote host server and send that parameter list to the processing component 318. The transmission of the emulation parameters to processing component 318 as shown at step 622. Circuit activation program 312 will then issue request to enable or disable the appropriate hardware circuitry in reconfigurable component 322 as show at step 624 and also activate or deactivate the necessary circuitry emulated in the platform emulation as shown at step 626. After executing the appropriate “soft circuits” included in the platform emulation, the emulation parameters will be stored in local memory 300 as shown at step 450 in FIG. 4D. The remaining steps in the process shown in FIG. 4D will then be followed by the user device as was previously described.

Returning now to FIG. 6A, in the event the user device determines that a compatible platform emulation does exist locally for the application then the process step set forth in FIG. 6C will be followed. FIG. 6C is a flow diagram showing the steps involved in creating an optimized platform emulation for the selected application. As shown at decision step 628, the user device will determine whether the available platform emulation is optimal for the selected application. Optimal in this context means a platform emulation that is capable of supporting the processing and storage requirements of the selective application. If an optimal platform emulation does exist, then the user device 108 will retrieve the emulation parameters as shown at step 630, send enable or disable hardware circuit request to reconfigurable components 322 as shown at step 632 and send activate or deactivate soft circuit request to enable certain “soft circuits” in the platform emulation as shown at step 634. Afterwards the user device will perform the process set fort on FIG. 4D, which was previously described herein.

Returning to FIG. 6C, in the event the platform emulation will determine not to be optimal as shown at step 628 then the user will be prompted to elect whether to develop an optimized platform emulation as shown at decision step 636. If an optimized platform emulation is required by the user, then application dispatch program 308 will issue a request to generate an optimized platform emulation as shown at step 638 and then the circuit activation program will receive the emulation parameters as well as the newly generated and optimized platform emulation as shown at step 622 issue request to the processing component 318 to enable or disable the appropriate hardware circuitry in reconfigurable component 322 which request as shown at step 624, and it will also send a request to activate or deactivate the appropriate “soft circuits” in the optimized platform emulation as shown at step 626. Afterwards the process shown in FIG. 4D will be executed to complete the storage of the emulation parameters and local memory 300 as shown at step 450, to perform relevant integrity checks as shown at step 452 and to confirm the processing requirements of the desired application as shown at step 454. The circuit configuration for the optimized platform emulation will be stored as shown at step 458 and the selected application program will be executed on the platform architecture as shown at step 460 and the results of the execution of this application will be displayed on the desired electronic device used by the end user as shown at step 462. The user profile stored in the data component will be updated with additional information on the selected application program to correlate data on both the application selected and the frequency of selection made by the end user of a particular device in a particular household 106 which process is provided by step 464. The user device will then return to a wait state and monitor for a new application selection as shown at step 466.

Returning now to FIG. 5A, if the application selected by the user is determined to be available locally as shown at decision step 502, then the relevant application parameters will be retrieved by the user device as shown at step 510 and a desired platform emulation will be generated as shown at step 512. This platform emulation will be verified and tested by the user device as shown at step 514 and this test will determine whether the generated platform emulation passes appropriate execution tests to ensure the successful operation of the selected application, which test is identified at decision step 516. If the tests are satisfactory, then the platform emulation will be requested by the dispatch program for execution (shown at step 518) and after execution the application dispatch program will return to a wait state as shown at step 520. In the event the verification test of the platform emulation is unsuccessful, then verification and testing of the platform emulation will be performed again until a testing threshold has been exceeded as implied by decision step 522. If the test threshold has been exceeded, the process will then time out as shown at step at 524. However, if the test threshold has not been exceeded then the testing will be performed again to ensure that the platform emulation is fully capable of executing on the user device in support of the selected application program.

After the application dispatch process has entered into a wait state for a new user request, the user device will continue to monitor for such a request, as shown at decision step 526. In the event no such requests are received, a second threshold will be analyzed to determine if it has been exceeded, as shown at decision step 528. If this threshold has been exceeded, then the application dispatch program will time out and return as shown in step 530.

Returning to the decision step at 528, if the waiting threshold has not been exceeded, then the application dispatch program will return to a wait state, where it will await a user request for a new application program. In addition as shown on FIG. 5B, if a user request for an application program is received while the application dispatch program is in its wait state as shown at step 526, then the flow of operations for the application dispatch program will return to step 500 and begin anew.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein.

What is claimed is:

1. A computer-implemented method for executing a platform-dependent application, the method comprising:
obtaining a request to execute the platform-dependent application;
obtaining configurable platform parameters corresponding to an emulation architecture for execution of the platform-dependent application;
generating the emulation architecture according to the configurable platform parameters; and
executing the platform-dependent application on the emulation architecture.

2. A configuration apparatus comprising:
a data gathering component operative to monitor user activity of a configurable electronic device;
a device configuration component operative to configure the configurable electronic device based on the user activity monitored by the data gathering component;
a compilation component operative to compile data on the monitored user activity and the configuration of the configurable electronic device; and
a data component operative to store the compiled data on the monitored user activity and the configuration of the configurable electronic device corresponding to the user activity.

3. A configurable platform apparatus comprising:
a memory;
a processor coupled to the memory;
configurable platform circuitry coupled to the processor; and
operative to:
obtain a request to execute a platform-dependent application;
obtain configurable platform parameters corresponding to an emulation architecture for execution of the platform-dependent application;
generate the emulation architecture according to the configurable platform parameters; and
execute the platform-dependent application on the emulation architecture.

4. A computer readable medium having instructions for:
obtaining a request to execute a platform-dependent application;
obtaining configurable platform parameters corresponding to an emulation architecture for execution of the platform-dependent application;
generating the emulation architecture according to the configurable platform parameters; and
executing the platform-dependent application on the emulation architecture.

5. A system operative to generate a platform emulation based on a selected application program, the system comprising:
a user device, an electronic device, a networked link between the user device and the electronic device;
the user device including a plurality of components and having information stored thereon for generating the platform emulation, the user device operative to execute the platform emulation and to execute the application program on the platform emulation; and
the electronic device operative to display information from the execution of the application program on the platform emulation.

6. The system of claim 5 wherein the plurality of components includes a central processing component, a memory, a reprogrammable component, a data component, a network interface component, an input/output component and a plurality of plug-in docks.

7. The system of claim 6 wherein the memory includes at least an application dispatch program, a circuit activation program and a plurality of emulation parameters, the plurality of emulation parameters comprising the information stored on the user device for generating the platform emulation.

8. The system of claim 5 further comprising a control and operations facility having a remote server, the remote server operative to store a plurality of application programs and to generate the platform emulation based on the information stored on the user device and to download the platform emulation to the user device.

9. The system of claim 8 wherein the information stored on the user device comprises a plurality of emulation parameters.

10. The system of claim 7 wherein the central processing component is operative to execute the application dispatch program to request the generation of the platform emulation when the selected application program is to be executed on a platform other than a default platform of the user device.

11. The system of claim 7 wherein the central processing component is operative to execute the application dispatch program to request the selected application program from the plurality of stored application programs when the selected application program is not resident on the user device.

12. The system of claim 11 wherein the remote server downloads the selected application program to the user device after receiving the request from the application dispatch program.

13. The system of claim 9 wherein the platform emulation is generated on a remote server based on the information stored on the user device and downloaded to the user device for execution.

14. The system of claim 7 wherein the central processing component is operative to retrieve the platform emulation from the memory when the selected application program is to be executed on a platform other than a default platform of the user device.

15. The system of claim 7 wherein the central processing component is operative to execute the application dispatch program to request the generation of the platform emulation on a remote server when the selected application program is provided on a plug-in cartridge inserted into one of the plurality of plug-in docks and to be executed on a platform other than a default platform of the user device.

16. The system of claim 15 wherein the remote server downloads the platform emulation to the user device after receiving the request from the application dispatch program.

17. The system of claim 7 wherein the circuit activation program is operative to configure a plurality of reconfigurable circuits comprising the reprogrammable component based on the platform emulation executed by the central processing component.

18. The system of claim 7 wherein the input/output component is operative to display the information produced by the execution of the application program on the platform emulation on a user-specified electronic device.

19. The system of claim 7 wherein the data component is operative to store a user profile, the user profile having a plurality of fields including at least a field for storing information identifying the selected application program and a field for storing information on a usage frequency for the selected application program.

20. The system of claim 6 wherein the reprogrammable component is a field-programmable-gate-array (FPGA) circuit.

21. The system of claim 6 wherein the reprogrammable component comprises an electrically erasable and programmable read-only memory (EEPROM).

22. The system of claim 6 wherein the reprogrammable component is a partially-reconfigurable field programmable gate array (PRFPGA).

23. The system of claim 6 wherein the reprogrammable component is an electrically programmable read-only memory (EPROM).

24. The system of claim 19 wherein the plurality of fields in the user profile further includes a field for storing a user's personal avatar, a field storing a geographic region identifier and a field for storing an associative data set, the associative data set including matches between a user's selected application programs and the application programs selected by other users in the same geographic region.

25. The system of claim 5 further comprising a plurality of intermediate processing nodes, at least one intermediate node controlling the processing and flow of information into a distinct geographic region, each distinct geographic region including a plurality of users having data components storing the same geographic region identifier.

26. The system of claim 8 further comprising a plurality of intermediate processing nodes, at least one intermediate node controlling the processing and flow of information into a distinct geographic region, each distinct geographic region including a plurality of users having data components storing the same geographic region identifier.

27. The system of claim 7 wherein the circuit activation program is operative to control at least one of the activation, de-activation, enablement and disablement of at least one of the plurality of reconfigurable circuits provided by the reprogrammable component.

28. The system of claim 6 wherein the data component comprises an application selection monitor operative to monitor each application program selection, a hybrid inference engine operative to analyze each application selection monitored by the application selection monitor and to compare each selected application program to previous application program selections for the electronic device, and an emulation identifier operative to identify a platform emulation for execution of each selected application program.

29. The system of claim 6 wherein the data component is operative to store a user profile, a selection identifier for each selected application program, and an emulation identifier for each platform emulation executed for each selected application program.

30. The system of claim 6 wherein the emulation identifier identifies the platform emulation from pre-designated values stored in the memory.
